(19) United States
(12) Patent Application Publication
(10) Pub. No.: US 2010/0304037 A1
(43) Pub. Date: Dec. 2, 2010

(54) Thermal Barrier Coatings and Application Methods

(75) Inventors: Benjamin J. Zimmerman, Enfield, CT (US); David A. Litton, West Hartford, CT (US); John F. Blondin, South Windsor, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 12/475,913

(22) Filed: Jun. 1, 2009

(51) Int. Cl. C23C 10/00; B05D 1/00; C23C 28/00; C23C 4/08; F01D 5/28

(52) U.S. Cl. 427/456; 427/240; 427/241; 427/446; 427/261; 427/264; 118/722

(57) ABSTRACT

A gas turbine engine component has a metallic substrate. A coating is on the substrate. A barrier coat is applied while varying a speed of the component rotation so as to provide a corresponding microstructure to the barrier coat.

### BACKGROUND

The disclosure relates gas turbine engines. More particularly, the disclosure relates to thermal barrier coatings for gas turbine engines.

Gas turbine engine gaspath components are exposed to extreme heat and thermal gradients during various phases of engine operation. Thermal-mechanical stresses and resulting fatigue contribute to component failure. Significant efforts are made to cool such components and provide thermal barrier coatings to improve durability.

Exemplary thermal barrier coating systems include two-layer thermal barrier coating systems. An exemplary system includes NiCoCrAlY bond coat (e.g., low pressure plasma sprayed (LPPS)) and a yttria-stabilized zirconia (YSZ) thermal barrier coat (TBC) (e.g., air plasma sprayed (APS) or electron beam physical vapor deposited (EBPVD)). Prior to and while the barrier coat layer is being deposited, a thermally grown oxide (TGO) layer (e.g., alumina) forms atop the bond coat layer. As time-at-temperature and the number of cycles increase, this TGO interface layer grows in thickness. U.S. Pat. Nos. 4,405,659 and 6,060,177 disclose exemplary systems.

Exemplary TBCs are applied to thicknesses of 5-40 mils (0.1-1.0 mm) and can contribute to a temperature reduction of the base beta of up to 300° F. temperature reduction to the base metal. This temperature reduction translates into improved part durability, higher turbine operating temperatures, and improved turbine efficiency.

### SUMMARY

One aspect of the disclosure involves a gas turbine engine component comprising a metallic substrate. A coating is on the substrate. A barrier coat comprises a microstructure associated with a varied rotational speed during coating.

In various implementations, the coating includes a bond coat and the barrier coat is atop the bond coat. A TGO may be between the bond coat and barrier coat.

Another aspect of the disclosure involves a method for coating a gas turbine engine component. A bond coat is applied to a substrate of the component. A barrier coat is applied atop the bond coat. The applying of the barrier coat comprises rotating the substrate as the barrier coat is applied and varying the speed of rotation.

In various implementations, the method may be implemented in the remanufacturing of a baseline component or the reengineering thereof. The baseline component may have a barrier coat which was applied at a single rotational speed and has a corresponding microstructure.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially schematic sectional view of coated substrate.

FIG. 2 is a flowchart of a process for coating the substrate of FIG. 1.

FIG. 3 is a partially schematic view of an apparatus for applying a thermal barrier coating to the substrate.

FIG. 4 is a sectional electronmicrograph of a coated substrate.

FIG. 5 is a sectional electronmicrograph of a baseline coated substrate.

Like reference numbers and designations in the various drawings indicate like elements.

### DETAILED DESCRIPTION

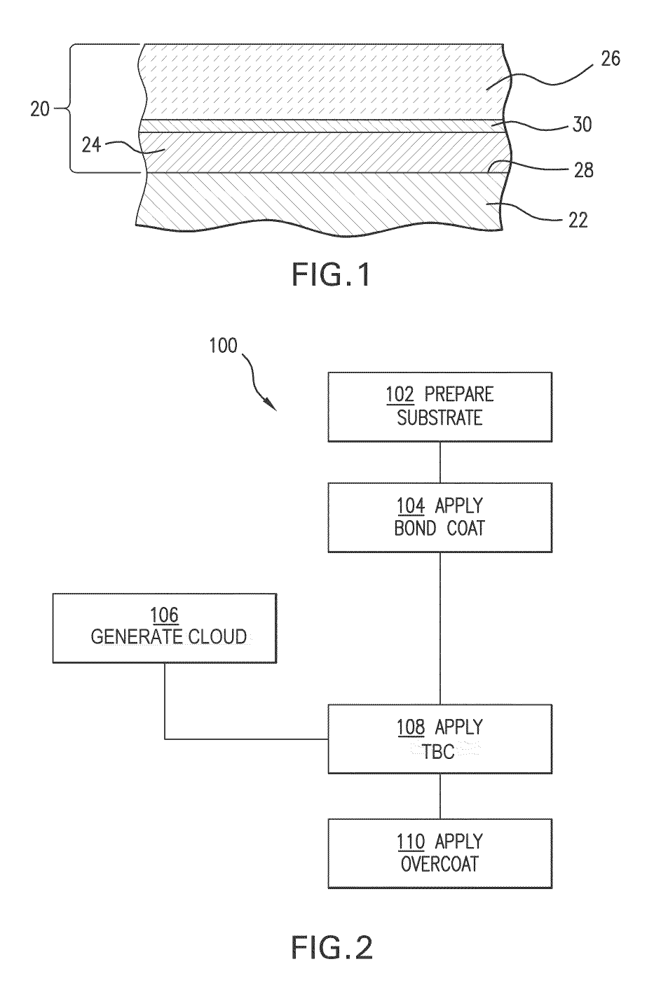

FIG. 1 shows a coating system 20 atop a superalloy substrate 22. The system may include a bond coat 24 atop a surface 28 of the substrate 22 and a TBC 26 atop the bond coat 24. A TGO 30 may form at the interface of the bondcoat to the TBC.

In an exemplary embodiment, the substrate is a cast component of a gas turbine engine. Exemplary components are hot section components such as combustor panels, turbine blades, turbine vanes, and air seals. Exemplary substrate materials are cobalt-based superalloys or nickel-based superalloys. In an exemplary method, the cast substrate is cleaned 102. The bond coat is then applied or deposited 104. One exemplary bond coat is a MCrAlY which may be deposited by a thermal spray process (e.g., air plasma spray or low pressure plasma spray) or by an electron beam physical vapor deposition (EBPVD) process such as described in U.S. Pat. No. 4,405,659. An alternative bond coat is a diffusion aluminide deposited by vapor phase aluminizing (VPA) as in U.S. Pat. No. 6,572,981. An exemplary characteristic (e.g., mean or median) bond coat thickness is 4-9 mil (100-230 μm).

In the exemplary embodiment, a ceramic vapor cloud is generated 106 causing the TBC is applied or deposited 108 from the cloud directly atop the exposed surface of the bond coat 24 or the pre-existing TGO 30. An exemplary TBC comprises rare-earth stabilized zirconia applied by electron beam physical vapor deposition (EBPVD), more particularly, yttria-stabilized zirconium oxide, also known as yttria-stabilized zirconia (YSZ) (e.g., 6-8% yttria by weight, with the nominal 7% yttria being designated 7YSZ). As is discussed further below, the substrate is rotated during TBC deposition. The speed of rotation may be varied to produce a TBC microstructure which has modified properties relative to a baseline TBC deposited at a single rotational speed.

An overcoat (if any) may then be applied 110. An exemplary overcoat is a chromia-alumina combination as disclosed in U.S. Pat. No. 6,060,177.

The modified barrier coating can be applied to a wide variety of bond coats. Such bond coats may be applied by air plasma-spray (APS), low pressure plasma-spray (LPPS), chemical vapor deposition, high velocity oxygen fuel (HVOF), flame spray, electron beam physical vapor deposition (EB-PVD), detonation spray, cathodic arc, and sputtering.

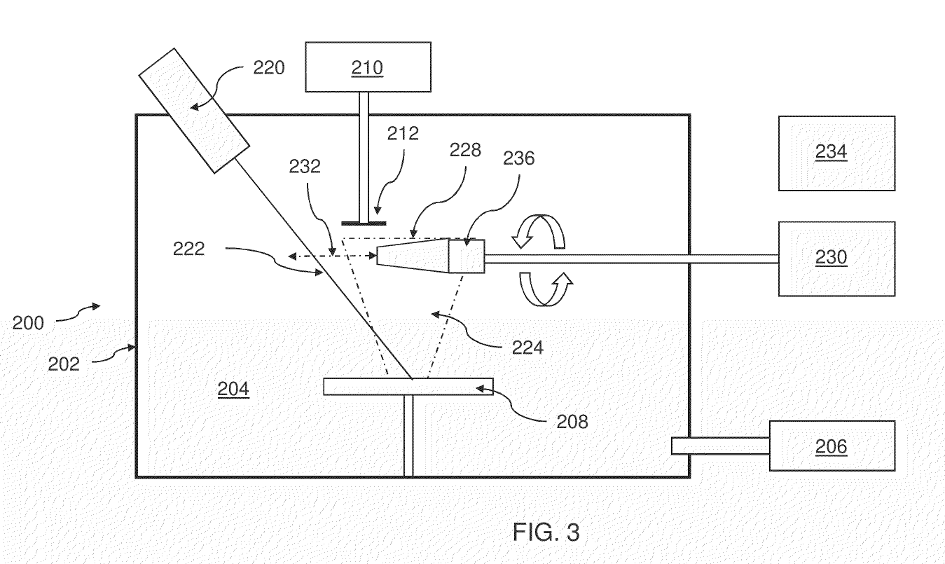

FIG. 3 shows an exemplary electron beam physical vapor deposition system 200 for depositing the TBC. The system 200 includes a vessel or chamber 202 having an interior 204. A vacuum pump 206 is coupled to the vessel to evacuate the interior. A ceramic target 208 is located in the interior. An oxygen source 210 may be positioned to introduce oxygen to the interior 204 via a manifold 212. An electron beam source 220 is positioned to direct an electron beam 222 to the target to vaporize a surface of the target to create a vapor cloud 224. A fixture or holder 236 is positioned in the chamber to hold a component (e.g., a turbine blade or vane) 228 exposed to the vapor cloud 224. The vapor cloud condenses on the component to form the TBC.

A motor 230 is coupled to the holder to rotate the holder and component about an axis 232. A controller 234 (e.g., a microcontroller, microcomputer, or the like) may be coupled to the motor, the electron beam source, the vacuum pump, oxygen source and/or any other appropriate components, sensors, input devices, and the like to control aspects of system operation. The exemplary controller may be programmed (e.g., via one or both of software and hardware) to vary a rotational speed of the holder and component about the axis during deposition.

The TBC is built up over the course of many rotations. By varying the rotational speed, the buildup at any given location on the component will be the result of passes at the different speeds. Each rotational pass builds up a small sublayer of the TBC (e.g., having a sublayer thickness of less than 10 micrometer, more narrowly 0.05-7.0 micrometer or, yet more narrowly 0.1-2.0 micrometer or 0.2-2.0 micrometer). In the examples of the table below, the rotational speed is alternated between a low speed and a high speed, each for a common angular interval. Although the exemplary intervals all less than 360 degrees, intervals of more than 360 degrees may be possible.

The deposition causes the buildup atop any given location on the component to be composed of regions having been deposited at combinations of the two different speeds. Depending upon the particular angular intervals chosen, these regions may be characterized by something as finely distributed as alternating single pass sublayers at each of the two speeds. Alternatively, various of the regions may be produced by contiguous groups of multiple passes at a given speed (e.g., to locally form one sublayer) alternating with contiguous groups of passes at the other speed(s) (to locally form one or more additional sublayers). Exemplary thicknesses for each of these sublayers is less than 8% of the total TBC thickness, more narrowly 0.005-6% or, yet more narrowly 0.02-2.6% or 0.7-2.0%. Alternatively characterized, of the total amount of TBC (either overall or at any given location) may be composed of at least 50% being characterized by having such layer thicknesses or having no single speed region of more than 5% of the total volume or local thickness. Exemplary overall local or average (mean or median) total TBC thickness is 3.0-12.0 mil (76 micrometer-0.3 mm).

The low rate may consist essentially of a single speed or multiple speeds in a range of 1-30 rpm while the high rate may consist essentially of a single speed or multiple speeds in a range of 5-100 rpm. Alternatively described, the high rate may be 2-10 times the low rate. In one example, exemplary low speeds (rates) are no more than 10 rpm while exemplary high speeds are at least 12 rpm.

Speed change interval or frequency may be at least once per revolution or may be longer. In various examples, at least a tenth of the barrier coat may be deposited at the low speed or speed range and at least a third at the high speed or speed range.

### EXAMPLES

| | | | | | Thermal |
|---|---|---|---|---|---|
| | | | | | Conductivity |
| | Low | High | | | (Btu-in/ |
| | Speed | Speed | Interval | Erosion | hr-ft2-° F.) |
| Example | (RPM) | (RPM) | (degrees) | Rate | (W/mK) |
| 1 | 5 | 30 | 72 | 2.6 | 13.4 |
| | | | | | (1.93) |
| 2 | 2 | 30 | 72 | — | 11.9 |
| | | | | | (1.72) |
| 3 | 8 | 15 | 288 | 3.8 | 13.5 |
| | | | | | (1.95) |
| 4 | 2 | 15 | 288 | 3.5 | 12.5 |
| | | | | | (1.80) |
| Baseline | 30 | 30 | NA | 3.3 | 13.7 |
| | | | | | (1.98) |

Erosion was measured as grams of material loss per kilogram erodent when blasting with 27 micrometer alumina grit normal to the surface at a rate of 800 ft/s(243 m/s) and a temperature of 2000 F (1093 C). Thermal conductivity was measured at 2200 F (1204 C). Deposition parameters were as follows: test substrates were alumina coupons in lieu of a metallic substrate and bond coat; 7YSZ TBC deposition was performed to produce the TBC of 5 mils (0.13 mm) thickness. Approximate TBC deposition parameters were: a temperature of 1975 F (1079 C); a power of 77 kW; a pressure of 6 millitorr; and an oxygen flow rate of 900 sccm. The 2200 F (1204 C) temperature was selected as a typical temperature for a thermal barrier coating during the hotter parts of a given engine/aircraft mission. The 2000 F (1093 C) erosion test temperature was selected because it was the upper limit of the test equipment.

From the table, it can be seen that erosion resistance is not substantially negatively affected (if at all) through the use of variable rotation rate whereas there is some reduction in thermal conductivity.

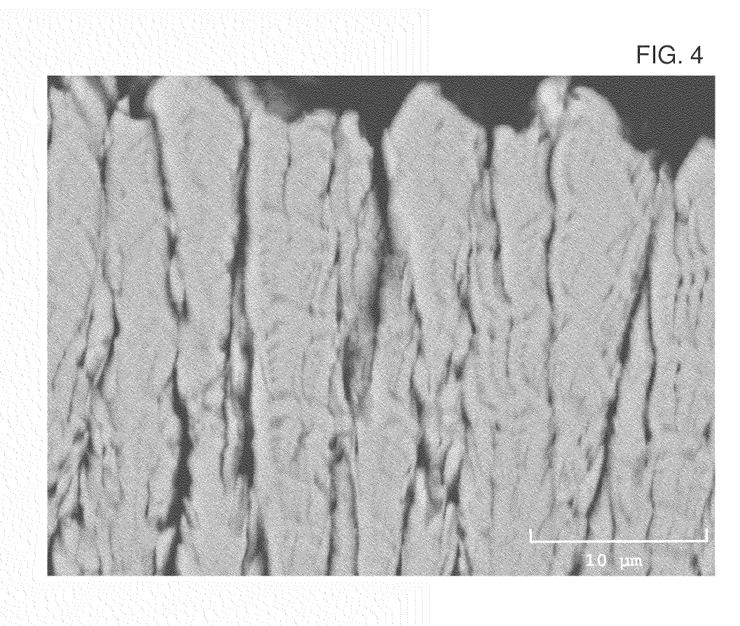

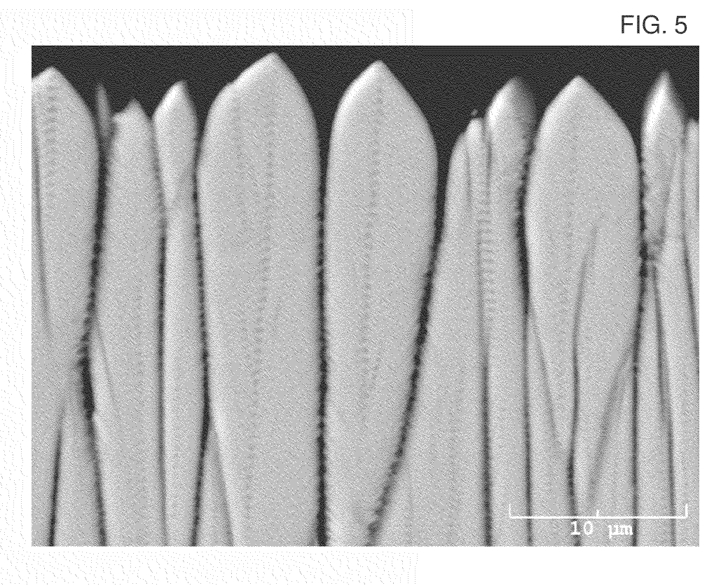

FIG. 4 is a sectional electromicrograph of Example 1. By contrast, FIG. 5 is a sectional electromicrograph of the baseline. It can be seen that the columnar microstructure in FIG. 4 is distorted due to the variable rotation rate. FIG. 5 shows a baseline clean columnar growth highly normal to the surface and linear. The highly constant layer thickness is seen in the equi-spaced dark spots on each column and in similar effects in the edge of the image of each column. FIG. 4 shows much greater differences than a mere variation in layer thickness. Although overall column growth is still fairly normal to the surface, localized growth varies in direction. This produces a columnar microstructure having layered variations in density, porosity and directionality. It also produces a ragged overall column shape. The ragged column shape can cause an interlocking of columns which may improve the mechanical properties of the coating. Specifically, the zig-zag microstructure is believed to offer a modulated density and directionality associated with the rotation changes so as to provide increased resistance to heat conduction and mechanical damage. Because the chemical composition remained a constant throughout the tested coating specimens, all variations in density for a specimen are due to changes in the microstructure (believed specifically due to the changes in the volume fraction of porosity between the various layers). The average density of all coating specimens was found to be within 10% of the baseline, but the local density within the various layers of the coatings would be expected to vary more. The exact magnitude of this variation was not determined.

A lower thermal conductivity may enable higher operating temperatures resulting in improved turbine efficiency. Improved erosion resistance in comparison to other reduced thermal conductivity coatings may yield longer component life for components in the combustor and turbine sections.

The coating may be applied to replace an existing baseline thermal barrier coating such as that of FIG. 5 which has a columnar microstructure having essentially constant density and directionality. The baseline TBC may be mechanically stripped prior to recoating.

Many variations are possible. For example, more than merely the two discrete speeds could be used. This includes the possibility of additional discrete speeds or a more continuous speed variation. In examples of continuous variation, relative times in different speed ranges or amounts of TBC deposited at those ranges may be substituted for the time intervals or amounts deposited at the discrete speeds. Additionally, although the same time interval is shown for each of the two speeds, different speeds might be associated with different intervals.

One or more embodiments have been described. Nevertheless, it will be understood that various modifications may be made without departing from the spirit and scope of the disclosure. For example, when applied as a reengineering of an existing component, details of the existing component may influence or dictate details of any particular implementation. Similarly, when applied as a modification of an existing process or with existing deposition equipment, details of the existing process or equipment may influence or dictate details of any particular implementation. Accordingly, other embodiments are within the scope of the following claims.

What is claimed is:

1. A method for coating a gas turbine engine component, the method comprising:
applying a barrier coat,
wherein the applying of the barrier coat comprises:
rotating the substrate as the barrier coat is applied; and
varying a speed of the rotation.

2. The method of claim 1 wherein:
the varying comprises rotating between a low rate of no more than 10 rpm and a high rate of at least 12 rpm.

3. The method of claim 1 wherein:
the varying comprises rotating between a low rate and a high rate of 2-10 times the low rate.

4. The method of claim 3 wherein:
the low rate consists essentially of a single speed in a range of 1-30 rpm and the high rate consists essentially of a single speed in a range of 5-100 rpm.

5. The method of claim 3 wherein:
the rotating consists essentially of said low rate and said high rate.

6. The method of claim 1 wherein:
the varying comprises a speed change frequency of at least once per revolution.

7. The method of claim 1 wherein:
the varying comprises depositing at least a tenth of the barrier coat at a speed of the rotation no more than 10 rpm and at least a third of the barrier coat at a speed of the rotation of at least 12 rpm.

8. The method of claim 1 wherein:
the barrier coat has a rare-earth based stabilized zirconia content of at least 50%, by weight.

9. The method of claim 1 wherein:
the barrier coat consists essentially of 7YSZ.

10. The method of claim 1 further comprising:
applying a bond coat to a substrate of the component and wherein the barrier coat is applied atop the bond coat.

11. The method of claim 10 wherein:
the applying of the bond coat is by low pressure plasma spray (LPPS); and
the applying of the barrier coat is by electron beam physical vapor deposition (EBPVD).

12. The method of claim 10 wherein:
the applying of the bond coat is by low pressure plasma spray (LPPS) of an NiCoCrAlY material; and
the applying of the barrier coat is by electron beam physical vapor deposition (EBPVD) of material comprising at least 50%, by weight, yttria-stabilized zirconia (YSZ).

13. A method for coating a gas turbine engine component, the method comprising:
applying a bond coat to a substrate of the component; and
applying a barrier coat atop the bond coat,
wherein the applying of the barrier coat comprises:
steps for obtaining a structure of the barrier coat characterized by a columnar microstructure having modulated density and directionality.

14. The method of claim 13 further comprising:
removing a baseline thermal barrier coating having a structure characterized by a columnar microstructure of essentially constant density and directionality.

15. An apparatus comprising:
a fixture for holding a component:
a motor coupled to the fixture for rotating the fixture about a fixture axis;
an electron beam physical vapor deposition source of a ceramic positioned to provide a vapor to the component on the fixture; and
a controller coupled to the motor to control the rotation and configured to vary a speed of the rotation so that a buildup of the ceramic at a given location on the component is formed by passes at varied speed.

16. The method of claim 15 wherein:
the controller is configured to vary the speed by alternating between a first speed and a second speed.
